(19) United States
(12) Patent Application Publication
(10) Pub. No.: US 2012/0140322 A1
(43) Pub. Date: Jun. 7, 2012

(54) Variable Binocular Loupe Utilizing Fluid Filled Lens Technology

(75) Inventors: Urban Schnell, Munchenbuchsee (CH); Julien Sauvet, Lyss (CH); William Egan, Jackson, WY (US)

(73) Assignee: Adlens Beacon, Inc., Iselin, NJ (US)

(21) Appl. No.: 13/309,254

(22) Filed: Dec. 1, 2011

Related U.S. Application Data
(60) Provisional application No. 61/418,440, filed on Dec. 1, 2010.

(51) Int. Cl. G02B 23/00; G02B 3/14

(52) U.S. Cl. 359/481

(57) ABSTRACT

A binocular loupe containing one or more sealed fluid filled lenses is described. The binocular loupe includes one or more eyepieces, a distance sensor, and control electronics. In an embodiment, the optical power of the fluid filled lenses may be adjusted to adjust the focal length associated with the binocular loupe. The distance sensor may be used to determine a distance between the binocular loupe and a sample while a controller compares the measured distance to the current optical power of the one or more sealed fluid filled lenses. The controller may transmit signals to one or more actuators coupled to one or more sealed fluid filled lenses to change the optical power of the one or more sealed fluid filled lenses based on the comparison.

### CROSS REFERENCE TO RELATED APPLICATIONS

This application claims priority to U.S. Provisional Patent Application No. 61/418,440 filed Dec. 1, 2010, which is incorporated herein by reference in its entirety.

### BACKGROUND

1. Field

Embodiments of the present invention relate to fluid-filled lenses and in particular to variable fluid-filled lenses.

2. Background

Basic fluid lenses have been known since about 1958, as described in U.S. Pat. No. 2,836,101, incorporated herein by reference in its entirety. More recent examples may be found in “Dynamically Reconfigurable Fluid Core Fluid Cladding Lens in a Microfluidic Channel” by Tang et al., Lab Chip, 2008, vol. 8, p. 395, and in WIPO publication WO2008/063442, each of which is incorporated herein by reference in its entirety. These applications of fluid lenses are directed towards photonics, digital phone and camera technology, and microelectronics.

Fluid lenses have also been proposed for ophthalmic applications (see, e.g., U.S. Pat. No. 7,085,065, which is incorporated herein by reference in its entirety). In all cases, the advantages of fluid lenses, such as a wide dynamic range, ability to provide adaptive correction, robustness, and low cost have to be balanced against limitations in aperture size, possibility of leakage, and consistency in performance.

### BRIEF SUMMARY

In an embodiment, a binocular loupe includes one or more sealed fluid filled lenses, one or more actuators coupled to the one or more sealed fluid filled lenses, a distance sensor, and a controller. The actuators are able to change the optical power of the one or more sealed fluid filled lenses. The distance sensor measures the distance between a user wearing the loupe and a sample under study by the user. The controller is configured to apply one or more signals to the one or more actuators coupled to the one or more sealed fluid filled lenses based on the distance measured from the distance sensor.

A method is described according to an embodiment. The method includes receiving a signal from a distance sensor, comparing the received signal to a state of curvature of one or more sealed fluid filled lenses, and adjusting the state of curvature of the one or more sealed fluid filled lenses based on the comparing. The signal received by the distance sensor is associated with the distance between a user and a sample under study by the user.

### BRIEF DESCRIPTION OF THE DRAWINGS/FIGURES

The accompanying drawings, which are incorporated herein and form a part of the specification, illustrate embodiments of the present invention and, together with the description, further serve to explain the principles of the invention and to enable a person skilled in the pertinent art to make and use the invention.

FIG. 1 illustrates a user wearing a binocular loupe and looking at an object, according to an embodiment.

FIG. 2 illustrates the components of a binocular loupe, according to an embodiment.

FIG. 3 illustrates a simulation of a magnified image, according to an embodiment.

FIG. 4 illustrates components within a magnifying optical element, according to an embodiment.

FIG. 5 displays a table comparing the focus of an object at varying working distances when using a sealed fluid filled lens vs. a classical static lens.

FIG. 6 is a flowchart of a method, according to an embodiment.

Embodiments of the present invention will be described with reference to the accompanying drawings.

### DETAILED DESCRIPTION

Although specific configurations and arrangements are discussed, it should be understood that this is done for illustrative purposes only. A person skilled in the pertinent art will recognize that other configurations and arrangements can be used without departing from the spirit and scope of the present invention. It will be apparent to a person skilled in the pertinent art that this invention can also be employed in a variety of other applications.

It is noted that references in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases do not necessarily refer to the same embodiment. Further, when a particular feature, structure or characteristic is described in connection with an embodiment, it would be within the knowledge of one skilled in the art to effect such feature, structure or characteristic in connection with other embodiments whether or not explicitly described.

Binocular loupes are commonly used by researchers, doctors, jewelers or any other profession which may benefit from receiving a magnified view of a sample under study by the user. Binocular loupes are easily worn over the eyes and provide a portable means for magnification. The use of conventional lenses within the loupe determines a specific distance, commonly named a working distance, at which the object being viewed is in focus for a given eye accommodation. Deviating away from this working distance will cause the object to appear blurry. Thus, a user wearing a binocular loupe, and not willing or able to accommodate, must keep his or her head stationary at a certain distance away from the sample under study in order to maintain clear focus of the sample. Changing a focal length, which is closely related to the working distance, can be achieved by swapping out the lenses within the loupe for different lenses of varying power. Doing so, however, is both tedious and time consuming. Furthermore, only discrete working distances may be set using conventional lenses with rigid shapes.

Fluid lenses have important advantages over conventional, rigid lenses. First, fluid lenses are easily adjustable. Thus, a binocular loupe requiring additional positive power correction to view near objects may be fitted with a fluid lens of base power matching a particular distance. The wearer of the binocular loupe may then adjust the fluid lens to obtain additional positive power correction as needed to view objects at intermediate and other distances.

Second, fluid lenses can be adjusted continuously over a desired power range. As an example, the focal length associated with one or more fluid filled lenses within a binocular loupe may be adjusted to precisely match the distance between the loupe and an object under study continuously, allowing the wearer of the binocular loupe to move closer or farther from the object while maintaining focus.

In an embodiment of a binocular loupe, one or more fluid lenses may be provided, each with its own actuation system, so that a lens for each loupe can be adjusted independently. This feature allows wearers, to adjust vision correction in each eye separately, so as to achieve appropriate correction in both eyes, which can result in better binocular vision and binocular summation.

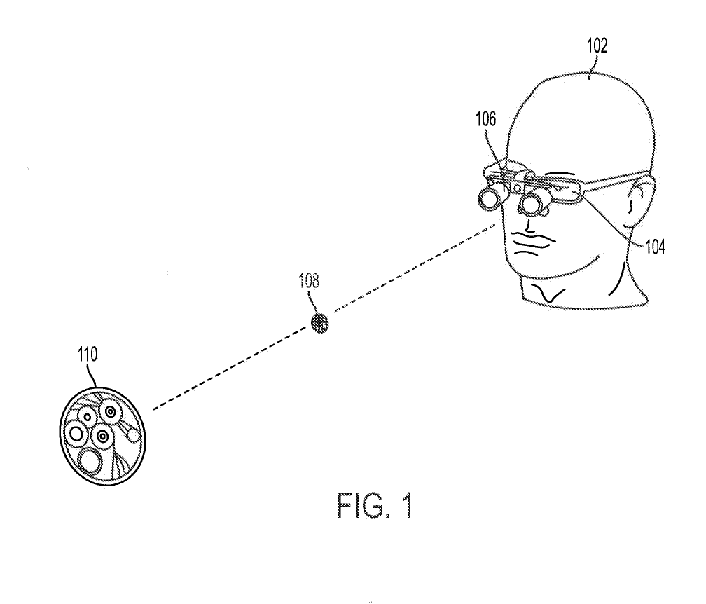

FIG. 1 illustrates a wearer 102 having glasses 104 and a binocular loupe 106 attached to the glasses 104, according to an embodiment. An exemplary object 108 under study is illustrated along with a virtual image 110 of object 108 demonstrating, for example, the magnification of object 108 performed by the optical elements within binocular loupe 106.

Glasses 104 may be any type of eyewear including, but not limited to, goggles, eye visors, spectacles, etc. Glasses 104 provide a support structure upon which to attach binocular loupe 106 in front of the eyes of wearer 102.

The magnification optics present within binocular loupe 106 provide wearer 102 with a magnified virtual image 110 of object 108. Object 108 may be any item under study by the wearer. It should be understood that virtual image 110 may be an image of any size in relationship to the size of the original object 108.

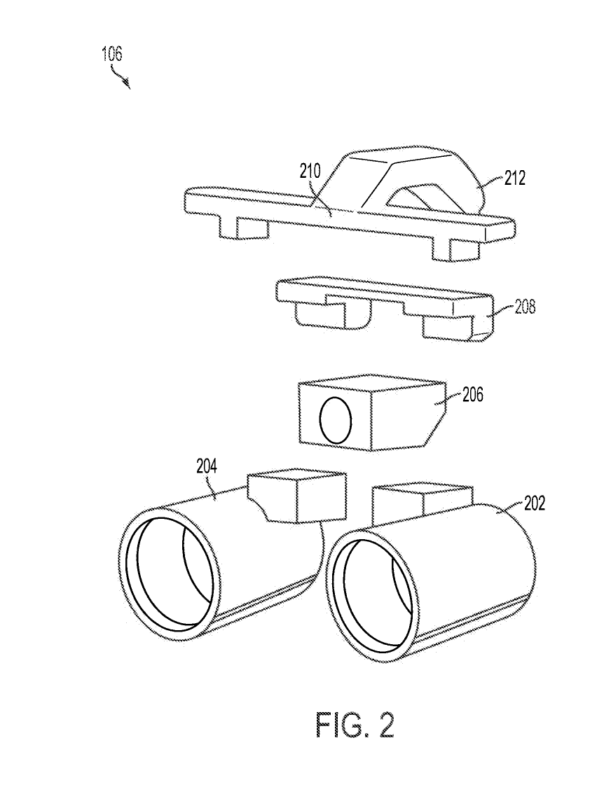

FIG. 2 illustrates various components of binocular loupe 106, according to an embodiment. Binocular loupe 106 includes a left eyepiece 202, a right eyepiece 204, a distance sensor 206, control electronics 208, and a bridge 210. Bridge 210 may further include a connector 212. It should be understood that binocular loupe 106 may be constructed in alternate ways beyond that illustrated in FIG. 2 without deviating from the scope or essence of the invention. Furthermore, binocular loupe 106 may contain only a single eyepiece.

Left eyepiece 202 and right eyepiece 204 contain optical elements utilized for modifying light passing through the elements. In one example, the optical elements refract the light resulting in a magnification of object 108 disposed at a particular focal length associated with the optical elements. The optical elements present within left eyepiece 202 and right eyepiece 204 may be the same or different. The optical elements within at least one eyepiece include a sealed fluid filled lens. Affecting the shape of the sealed fluid filled lens also affects the focal length (working distance) associated with the optical elements. More details regarding the sealed fluid filled lens are explained later.

Distance sensor 206 transmits a signal and measures a return signal to determine a distance between binocular loupe 106 and an object upon which the transmitted signal impinges. In an embodiment, distance sensor 206 includes an optical window facing the front of binocular loupe 106 which allows for signals to pass through with minimal attenuation. In an embodiment, distance sensor 206 is disposed between left eyepiece 202 and right eyepiece 204. Distance sensor 206 may determine the distance based on comparing the amplitude of the transmitted signal to the amplitude of the returned signal. The amount of attenuation of the signal as it passes through the air may be related to the distance traveled assuming certain coefficients regarding the air are known, such as those associated with humidity. Alternatively, distance sensor 206 may act as an interferometer and determine the distance based on an interference signal generated by combining the return signal with a reference signal. The signals transmitted and received by distance sensor 206 may be any signals known by those skilled in the art for the purpose of distance measuring including, but not limited to, infrared, visible light, acoustic waves, etc.

Control electronics 208 may include any arrangement of integrated circuits, discrete components, or a mixture of both. In an embodiment, control electronics 208 includes a controller which compares the distance measured from distance sensor 206 to the current state of curvature of one or more fluid filled lenses within left eyepiece 202 and right eyepiece 204. The curvature of the one or more fluid filled lenses directly affects the focal lengths associated with the optical elements within left eyepiece 202 and right eyepiece 204. According to an embodiment, if the distance measured from distance sensor 206 and the focal length associated with the optical elements within either left eyepiece 202 or right eyepiece 204 are not equal, the controller transmits a signal to one or more actuators (not shown) coupled to the one or more fluid filled lenses to adjust the focal length in a closed-loop controlled manner. In an embodiment, the controller only transmits a signal to the one or more actuators if the distance measured by distance sensor 206 is within a particular range, for example, between 340 mm and 520 mm. This limitation may be imposed to eliminate an attempt to either stretch or contract the fluid filled lens beyond its capabilities.

Bridge 210 may be utilized to support each of left eyepiece 202, right eyepiece 204, distance sensor 206 and control electronics 208 together in a single structure. Connector 212 may be used to attach bridge 210 to another support structure such as a pair of glasses worn by a user.

Binocular loupe 106 may include modular components. For example, left eyepiece 202, right eyepiece 204, distance sensor 206, and control electronics 208 may each be removed or reattached to bridge 210 and/or one another via any mechanism which would allow such actions to be performed in a continuous manner without causing harm to any of the components.

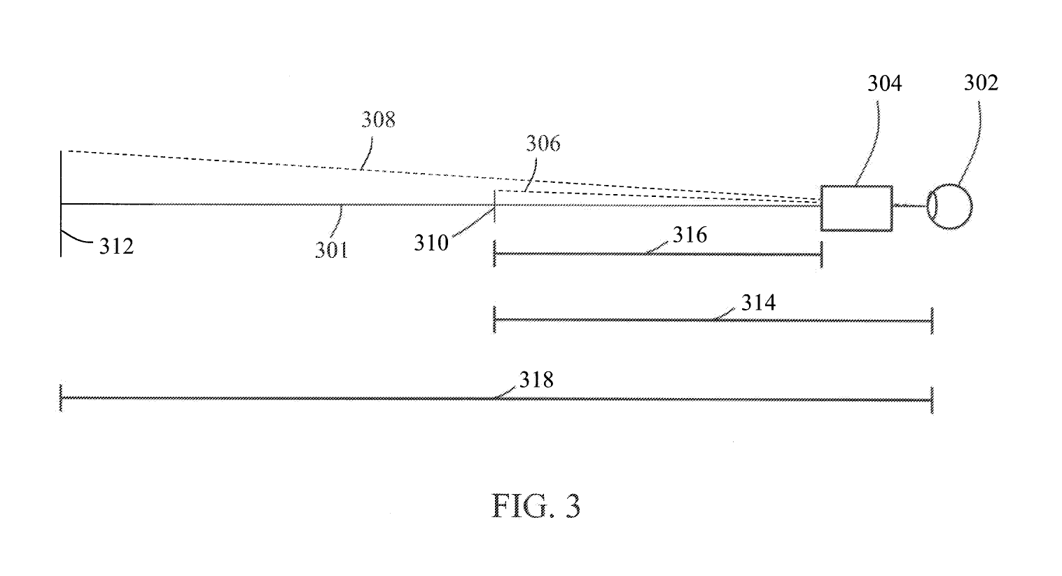

FIG. 3 illustrates the magnification of an object received by a user's eye 302, according to an embodiment. A light ray 306 reflects off of an object associated with an object plane 310 some distance from a magnifier 304. In an embodiment, magnifier 304 includes one or more fluid filled lenses. Light ray 306 impinges upon magnifier 304, where it is refracted by the optical elements within and is directed to eye 302. The light that eye 302 ultimately receives is analogous to a virtual light ray 308 which provides an image of a virtual object associated with a virtual object plane 312. The virtual object is a magnified image, received by eye 302, of the real object associated with object plane 310. The virtual object has no tangible manifestation. In an embodiment, eye 302, magnifier 304, object plane 310 and virtual plane 312 are all aligned along axis 301.

Working distance 314 is the distance between eye 302 and object plane 310. Focal distance 316 is the distance between magnifier 304 and object plane 310. The focal length associated with the optical elements within magnifier 304 must equal focal distance 316 in order for the object at object plane 310 to be in focus. Virtual image distance 318 is the distance that would exist between eye 302 and the virtual object associated with virtual object plane 312. In an example, virtual image distance is about 1 meter for a working distance 314 of about 420 mm. In an embodiment, the distance between eye 302 and magnifier 304 is small and remains substantially constant while a binocular loupe is worn by a user. As a result, working distance 314 and focal distance 316 are directly related and in many optical applications are considered to be synonymous.

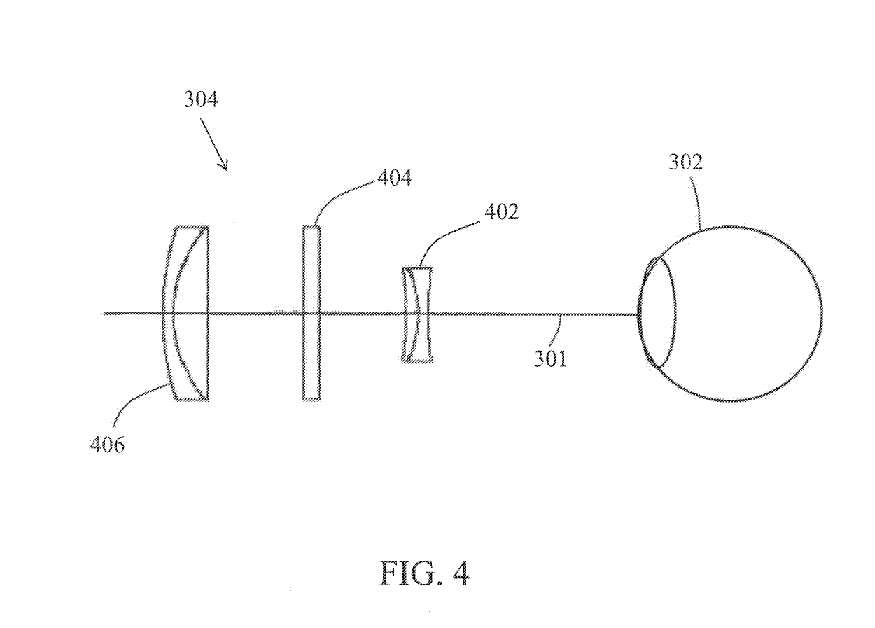

FIG. 4 illustrates an exemplary arrangement of optical elements within magnifier 304. In an embodiment, a fluid filled lens 404 is disposed between a first lens assembly 402 and a second lens assembly 406.

The curvature associated with fluid filled lens 404 causes light passing through to bend at an angle proportional to the imposed curvature. In an embodiment, the curvature of fluid filled lens 404 may be controlled via an electromechanical actuator (not shown) coupled to a fluid reservoir (not shown). The electromechanical actuator may apply a pressure to the fluid reservoir which forces fluid into fluid filled lens 404, thus decreasing the radius of curvature associated with fluid filled lens 404. The electromechanical actuator may also release pressure on the fluid reservoir to increase the radius of curvature associated with fluid filled lens 404. The electromechanical actuator may be a piezoelectric actuator as described in U.S. patent application Ser. No. 13/270,910 which is herein incorporated by reference in its entirety.

In an embodiment, the optical power associated with each of first lens assembly 402 and second lens assembly 406 is fixed. As used herein, the term “lens assembly” may include only a single lens or it may include multiple lenses depending on the overall design of the lens system. In an embodiment, the optical power of fluid filled lens 404 can be changed within a certain range. The range may be based on the material properties of fluid filled lens 404. For example, the possible optical power ranges of fluid filled lens 404 are between 0 and 2.7. Larger ranges of optical powers may be possible if using materials with higher durability and flexibility.

According to an embodiment, the combination of second lens assembly 406 and fluid filled lens 404 sets the focal length associated with magnifier 304. As an example, second lens assembly 406 may have an associated focal length of 520 mm. Changing the optical power of fluid filled lens 404 may further decrease the focal length from 520 mm to some minimum value. For example, the minimum focal length may be 340 mm.

In an embodiment, first lens assembly 402 has a concave shape. First lens assembly 402 may provide magnification of light received from fluid filled lens 404. In an embodiment, the light passes through first lens assembly 402 and onto the eye of a wearer of a binocular loupe.

It should be understood that although magnifier 304 is illustrated as containing a single fluid filled lens with two other optical elements, magnifier 304 may contain any number of fluid filled lenses, each with an actuator capable of changing the curvature of the associated fluid filled lens. Additionally, magnifier 304 may contain any number of optical elements with fixed optical powers, and in any arrangement.

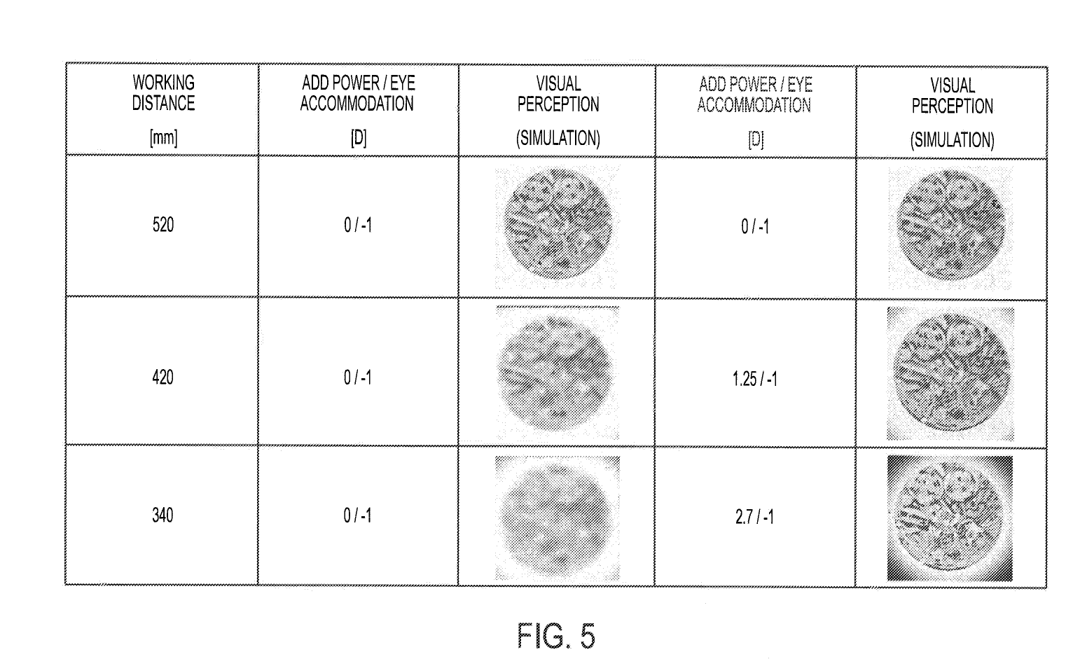

FIG. 5 displays a table containing simulated images a user would see at various working distances and with either fixed lenses or lenses with variable optical power. Simulated images at working distances of 520 mm, 420 mm, and 340 mm are displayed, as an example. The first column of images 502 provides simulated views of an object at each of the three working distances while using a magnifier with the same optical power and eye accommodation, i.e. magnification power. The second column of images 504 provides simulated views of the same object at each of the three working distances while using a magnifier with variable optical power and the same eye accommodation. In an embodiment, the variable optical power is provided by a fluid filled lens within the magnifier.

In an example, the optical power for the second column of images 504 changes from 0 to 1.25 to 2.7 as the working distance changes from 520 mm to 420 mm to 340 mm. The changing optical power, due to changing the curvature of the fluid filled lens within the magnifier, results in the object remaining in focus for each working distance even though the same eye accommodation is used, according to an embodiment.

In contrast, the optical power remains constant at 0 for the first column of images 502 resulting in the object being out of focus as the working distance decreases from 520 mm. Without the fluid filled lens, changing the optical power would require physically swapping out the optical elements within the magnifier.

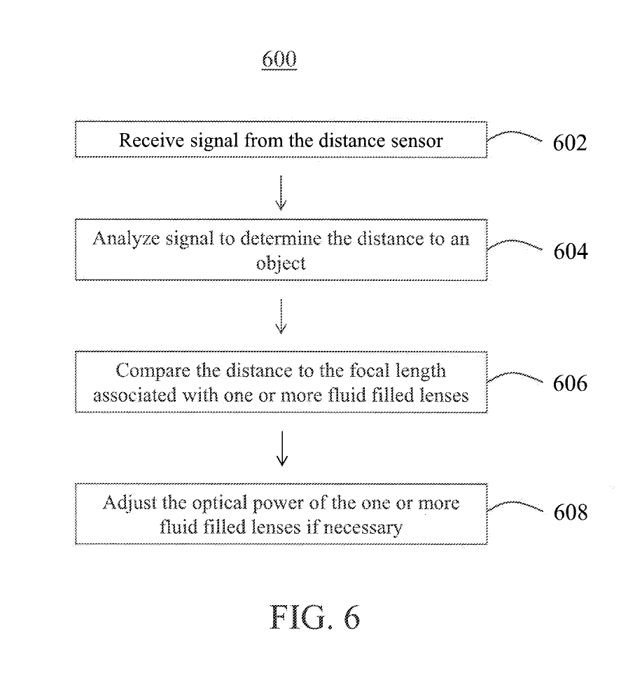

FIG. 6 illustrates an exemplary lens control method 600, according to an embodiment.

At block 602, a signal is received from a distance sensor. The signal is related to a distance between the distance sensor and an object under study by a user. It should be understood that the distance may similarly be related to a distance between a user and the object under study by the user. Alternatively, the distance may be any value measured by the distance sensor. The signal may be received either electronically or optically from the distance sensor. A distance measurement may correspond to a particular voltage amplitude, AC frequency, or any other type of modulation as would be understood by one skilled in the art.

At block 604, the received signal is analyzed to determine the associated distance.

At block 606, the signal corresponding to a particular distance is compared to the current focal length of one or more magnifiers. In an embodiment, each magnifier contains one or more fluid filled lenses. The focal length of each of the one or more magnifiers may be determined based on the optical power (directly related to curvature) of the one or more fluid filled lenses within each magnifier component. Using the exemplary magnifier illustrated in FIG. 4, if fluid filled lens 404 has an optical power of 0, then the focal length of magnifier 304 is equal to the focal length associated with second lens assembly 406 (or the reciprocal of the optical power associated with second lens assembly 406). Alternatively, if fluid filled lens 404 has an optical power greater than 0, then the focal length of magnifier 304 is equal to the focal length associated with both second lens assembly 406 and fluid filled lens 404 (the reciprocal of the added optical powers of both second lens assembly 406 and fluid filled lens 404).

The optical power of the one or more fluid filled lenses is also directly related to the curvature of the one or more fluid filled lenses. The curvature may be measured based on the amount of pressure applied by each actuator coupled to the one or more fluid filled lenses. In another embodiment, the curvature may be measured by an additional optical sensor. Alternatively, the curvature may be measured by a piezoresistive element.

At block 608, the optical power of the one or more fluid filled lenses is adjusted if necessary based on the comparison. In an embodiment, if the measured distance is equal to the focal length, then no adjustment is required. As a further example, if the measured distance is within a certain threshold range of the focal length, no adjustment is required. However, if the measured distance is beyond a certain threshold range from the focal length, adjustment may be necessary to the optical power of the one or more fluid filled lenses. In one example, the adjustment is made by changing the curvature of the one or more fluid filled lenses.

If the measured distance is greater than a threshold range above the focal length, then the optical power of the one or more fluid filled lenses is reduced. The optical power may be reduced by transmitting a signal to an actuator to reduce pressure on a liquid reservoir associated with a fluid filled lens. The movement of liquid into the reservoir increases the radius of curvature of the associated fluid filled lens, and thus decreases its optical power.

If the measured distance is less than a threshold range below the focal length, then the optical power of the one or more fluid filled lenses is increased. The optical power may be increased by transmitting a signal to an actuator to increase pressure on a liquid reservoir associated with a fluid tilled lens. The movement of liquid into the fluid filled lens decreases the radius of curvature of the associated fluid filled lens, and thus increases its optical power.

It should be understood that lens control method 600 may be stored as instructions on a computer readable storage medium and executed by a controller. Any computer readable storage medium may be used as would be known to those skilled in the art, including, but not limited to, RAM, flash memory, electronically erasable programmable read-only memory (EEPROM), hard disk drive, etc.

The pieces of the binocular loupe described, for example, but not limited to, the left and right eyepieces, bridge, and housings of the control electronics and distance sensor, etc, may be manufactured through any suitable process, such as metal injection molding (MIM), cast, machining, plastic injection molding, and the like. The choice of materials may be further informed by the requirements of mechanical properties, temperature sensitivity, optical properties such as dispersion, moldability properties, or any other factor apparent to a person having ordinary skill in the art.

The fluid used in the fluid filled lens may be a colorless fluid, however, other embodiments include fluid that is tinted, depending on the application, such as if the intended application is for sunglasses. One example of fluid that may be used is manufactured by Dow Corning of Midland, Mich., under the name “diffusion pump oil,” which is also generally referred to as “silicone oil.”

The fluid filled lens may include a rigid optical lens made of glass, plastic, or any other suitable material. Other suitable materials include, for example and without limitation, Diethylglycol bisallyl carbonate (DEG-BAC), poly(methyl methacrylate) (PMMA), and a proprietary polyurea complex, trade name TRIVEX (PPG).

The fluid filled lens may include a membrane made of a flexible, transparent, water impermeable material, such as, for example and without limitation, one or more of clear and elastic polyolefins, polycycloaliphatics, polyethers, polyesters, polyimides and polyurethanes, for example, polyvinylidene chloride films, including commercially available films, such as those manufactured as MYLAR or SARAN. Other polymers suitable for use as membrane materials include, for example and without limitation, polysulfones, polyurethanes, polythiourethanes, polyethylene terephthalate, polymers of cycloolefms and aliphatic or alicyclic polyethers.

A connecting tube between a fluid filled lens and a reservoir may be made ofone or more materials such as TYGON (polyvinyl chloride), PVDF (Polyvinyledene fluoride), and natural rubber. For example, PVDF may be suitable based on its durability, permeability, and resistance to crimping.

The various components of the binocular loupe may be any suitable shape, and may be made of plastic, metal, or any other suitable material. In an embodiment, the components of the binocular loupe assembly are made of a lightweight material such as, for example and without limitation, high impact resistant plastics material, aluminum, titanium, or the like. In an embodiment, the components of the binocular loupe assembly may be made entirely or partly of a transparent material.

The reservoirs coupled to the one or more fluid filled lenses may be made of, for example and without limitation, Polyvinyledene Difluoride, such as Heat-shrink VITON(R), supplied by DuPont Performance Elastomers LLC of Wilmington, Del., DERAY-KYF 190 manufactured by DSG-CANUSA of Meckenheim, Germany (flexible), RW-175 manufactured by Tyco Electronics Corp. of Berwyn, Pa. (formerly Raychem Corp.) (semirigid), or any other suitable material. Additional embodiments of the reservoir are described in U.S. Pat. Pub. No. 2011/0102735, which is incorporated by reference herein in its entirety.

Any additional lenses that may be included within either eyepiece of the binocular loupe assembly may be of any sufficiently transparent material and may be in any shape, including but not limited to, biconvex, plano-convex, plano-concave, biconcave, etc. The additional lenses may be rigid or flexible.

It is to be appreciated that the Detailed Description section, and not the Summary and Abstract sections, is intended to be used to interpret the claims. The Summary and Abstract sections may set forth one or more but not all exemplary embodiments of the present invention as contemplated by the inventor(s), and thus, are not intended to limit the present invention and the appended claims in any way.

The present invention has been described above with the aid of functional building blocks illustrating the implementation of specified functions and relationships thereof. The boundaries of these functional building blocks have been arbitrarily defined herein for the convenience of the description. Alternate boundaries can be defined so long as the specified functions and relationships thereof are appropriately performed.

The foregoing description of the specific embodiments will so fully reveal the general nature of the invention that others can, by applying knowledge within the skill of the art, readily modify and/or adapt for various applications such specific embodiments, without undue experimentation, without departing from the general concept of the present invention. Therefore, such adaptations and modifications are intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance.

The breadth and scope of the present invention should not be limited by any of the above-described exemplary embodiments, but should be defined only in accordance with the following claims and their equivalents.

What is claimed is:

1. A binocular loupe comprising:
one or more sealed fluid filled lenses;
one or more actuators coupled to the one or more sealed fluid filled lenses and configured to change the optical power of the one or more sealed fluid filled lenses;
a distance sensor configured to measure the distance between a user and an object under study by the user; and
a controller configured to apply one or more signals to the one or more actuators coupled to the one or more sealed fluid filled lenses based on a measurement received from the distance sensor.

2. The binocular loupe of claim 1, wherein the one or more actuators are electromechanical actuators.

3. The binocular loupe of claim 2, wherein the electromechanical actuators vary one or more pressures applied to one or more liquid reservoirs coupled to the one or more sealed fluid filled lenses.

4. The binocular loupe of claim 3, wherein the one or more pressures applied changes the curvature of the one or more sealed fluid filled lenses.

5. The binocular loupe of claim 4, wherein the applied changes to the curvature of the one or more sealed fluid filled lenses changes the power of the lenses in a range of 0 to 2.7.

6. The binocular loupe of claim 4, wherein the applied changes to the curvature of the one or more sealed fluid filled lenses changes the focal length associated with the binocular loupe in a range of 340 mm to 520 mm.

7. The binocular loupe of claim 1, wherein the distance sensor uses IR wavelengths.

8. The binocular loupe of claim 1, wherein the distance sensor is an ultrasonic sensor.

9. The binocular loupe of claim 1, wherein the distance sensor uses visible light wavelengths.

10. The binocular loupe of claim 1, further comprising a bridge containing the distance sensor and the controller.

11. A method comprising:
receiving a signal from a distance sensor, wherein the signal is associated with the distance between a user and an object under study by the user;
comparing the signal to an optical power associated with one or more sealed fluid filled lenses; and
adjusting the optical power of the one or more sealed fluid filled lenses based on the comparing.

12. The method of claim 11, wherein the receiving is performed continuously.

13. The method of claim 12, wherein the receiving continuously receives an optical signal.

14. The method of claim 12, wherein the receiving continuously receives an acoustic signal.

15. The method of claim 11, wherein the comparing further compares the signal to the radius of curvature of the one or more sealed fluid filled lenses.

16. The method of claim 11, wherein the adjusting the optical power is executed by adjusting the curvature of the one or more sealed fluid filled lenses.

17. The method of claim 16, wherein the adjusting the curvature is performed by one or more electromechanical actuators.

18. The method of 17, wherein the electromechanical actuators vary one or more pressures applied to one or more liquid reservoirs coupled to the one or more sealed fluid filled lenses.
